(19) United States
(12) Patent Application Publication
(10) Pub. No.: US 2026/0247087 A1
(43) Pub. Date: Aug. 20, 2026

(54) METHOD OF OPERATING A HEARING SYSTEM AND HEARING SYSTEM

(71) Applicant: Sivantos Pte. Ltd., Singapore (SG)

(72) Inventor: Stefan AMELING, Erlangen (DE)

(21) Appl. No.: 19/053,668

(22) Filed: Feb. 14, 2025

(51) Int. Cl. H04R 25/00

(52) U.S. Cl. CPC H04R 25/70; H04R 25/507; H04R 25/554; H04R 25/558; H04R 2225/61

(57) ABSTRACT

A method operates a hearing system which has a hearing aid, an interaction unit, a user interface for inputting a hearing-system-related user query, and a data processing section coupled to the user interface. The method includes: receiving the hearing-device-related user query by the user interface; analyzing the hearing-device-related user query by the data processing section; generating a response to the hearing-device-related user query by the data processing section; outputting the response to the user by the user interface; identifying an actionable item in the response by the data processing section, the actionable item indicates an adjustment for the hearing aid; generating an actionable control corresponding to the actionable item by the data processing section; presenting the actionable control to the user by the user interface; and performing, if the actionable control is activated by the user, the corresponding adjustment for the hearing aid. A corresponding hearing system is also described.

### FIELD AND BACKGROUND OF THE INVENTION

The invention concerns a method of operating a hearing system as well as such a hearing system. In particular, the invention relates to the field of assistive technologies, specifically to the integration of advanced data processing within help and support chatbots for hearing aid users.

A hearing system contains a hearing aid which is worn by a user during intended use. The hearing aid is dedicated to amplifying surrounding sounds to compensate for a hearing deficit of the user. A hearing system may also contain an interaction unit in communication with the hearing aid and to control the hearing aid.

Hearing aid users often require assistance in managing device settings and troubleshooting common issues of the hearing aid. Traditional help and support chatbots provide text-based guidance, which users need to follow step by step. This can be cumbersome for users to follow, especially if they involve multiple steps.

Unpublished U.S. patent application Ser. No. 18/935,872, which is incorporated herein by reference, is related to customizing a conversational AI (artificial intelligence) by personalized hearing aid text and media to solve hearing aid wearer issues in a human-like dialogue. This provides means to easily execute the steps for solving an issue a user has.

Reference is also made to U.S. Pat. No. 10,284,965 B2 and U.S. patent publication No. 2024/0 252 048A1 .

### SUMMARY OF THE INVENTION

It is an object of the invention to provide an improved method for operating a hearing system and a corresponding hearing system. In particular, intuitive and efficient assistance shall be provided to a hearing aid user in adjusting their hearing aid. Other objects may be derived from the following description.

The object is solved according to the invention by a method with the features according to the independent method claim and by a hearing system with the features according to the independent hearing system claim. Any description relating to the method applies mutatis mutandis to the hearing system and vice versa. Advantageous embodiments, further developments and variants are the subject of the dependent claims. The features of any two or more dependent claims may be combined to derive further advantageous embodiments. Insofar as steps of the method are described below, advantageous embodiments for the hearing system are derived by the hearing system being configured to execute one or several of these steps.

With the foregoing and other objects in view there is provided, in accordance with the invention, a method for operating a hearing system having a hearing aid, an interaction unit, a user interface for inputting a hearing-system-related user query, and a data processor coupled to the user interface. The method includes receiving a hearing-device-related user query by the user interface, analyzing the hearing-device-related user query by the data processor, generating a response to the hearing-device-related user query by the data processor, and outputting the response to the user by the user interface. An actionable item in the response is identified by the data processor, wherein the actionable item indicates a corresponding adjustment for the hearing aid. An actionable control corresponding to the actionable item is generated by the data processor. The actionable control is presented to a user by the user interface, and if the actionable control is activated by the user, the corresponding adjustment for the hearing aid is performed.

A core idea of the present invention is to provide intuitive and efficient assistance to a hearing aid user in adjusting their hearing aid directly through actionable controls embedded into a chatbot. The chatbot's responses are enhanced, i.e., augmented by context-aware, actionable controls. The controls are tailored to the specific topic and context discussed with the user. The user may, therefore, easily and directly adjust the hearing aid according to their immediate need by way of simply activating the provided actionable control. Thus, the invention provides means to the user for controlling their hearing aid directly through chatbot interactions.

The inventive method is a method for operating a hearing system having a hearing aid, an interaction unit, a user interface for inputting a hearing-system-related user query, and a data processing section coupled to the user interface. Preferably, the interaction unit is a device separate from the hearing aid (remote interaction unit), but in principle the interaction unit may also be integrated into the hearing aid (integrated interaction unit). In a possible embodiment, the user interface is part of the interaction unit which is a separate device. In another possible embodiment, the interaction unit and the hearing aid are separate devices and the latter acts as the user interface. Particularly if the interaction unit and the hearing aid are separate devices, both are suitably connected to each other for data exchange, e.g., via a Bluetooth or WiFi connection. In this application, it is assumed without loss of generality that the interaction unit is a remote interaction unit separate from the hearing aid.

A first step of the method is receiving the hearing-device-related user query by the user interface. The user interface may be a touchscreen or microphone of the interaction unit accepting the hearing-device-related user query as typed or spoken user input. In the alternative, the user may input the query as speech via a microphone of the hearing aid, which transmits the query to the interaction unit for processing by the data processing section. The hearing-device-related user query is a phrase describing a problem or question the user experiences in connection with use or operation of the hearing aid. Examples for the hearing-device-related user query are “Sound output is too loud”, “Everything sounds too soft!”, “I cannot hear my own voice”, and similar.

A second step of the method is analyzing the hearing-device-related user query by the data processing section. The data processing section may be part of a control unit of the interaction unit or the hearing aid (on-device solution). In the alternative, the data processing section is separate from the interaction unit, e.g., the data processing section is implemented as a cloud service and/or located on a server or the like and connected to the interaction unit via the internet (cloud solution). Analyzing the hearing-device-related user query may comprise searching the query for certain buzzwords or phrases and looking up corresponding responses in a database. Preferably, the data processing section comprises a smart retriever for analyzing the query. In a retrieval phase, the smart retriever fetches the most relevant, e.g., semantically most similar, documents from the database, e.g., vector store or knowledge base. In other words: the smart retriever fetches the documents that best match the query. Thus, it is ensured that only most relevant documents are coalesced with the query for the next phase, i.e., the generation of a response. Any database is either part of the hearing system or external thereto and accessed by the data processing section, e.g., via the internet.

A third step of the method is generating a response to the hearing-device-related user query by the data processing section. Preferably, the data processing section implements a chatbot for generating the response in response to the hearing-device-related user query. The user query and the response thereby take the form of a dialogue between the user and the chatbot. In a preferred embodiment, the data processing section uses retrieval-augmented generation (RAG) when generating the response. To do so, generating the response suitably constitutes a generation phase in which the coalesced and condensed context as defined by the documents retrieved in the retrieval phase are used to generate the response. In a preferred embodiment, the data processing section uses a large language model (LLM) for generating the response to the hearing-device-related user query. Thus, an LLM is used in the generation phase to generate a suitable response based on the context as determined from analyzing the query. It may be beneficial to apply additional prompt engineering to fashion the tone and format of the response. In a preferred embodiment, the data processing section implements a chatbot for generating the response in response to the hearing-device-related user query.

Referring to the example queries as described above in connection with the first step, respective exemplary responses are:
“Try decreasing the volume.”,
“If everything sounds too soft, there are several adjustments you can make:
a) Increase Volume: Open the hearing aid app and use the volume sliders to increase the hearing aid's volume.
b) Sound Balance: Adjust the bass and treble settings to make the sound clearer and louder.
c) Rocker Switch: Use the rocker switch on your hearing aid to increase the volume.
d) Consult Professional: If adjustments do not help, consult your hearing care professional for a thorough examination and recalibration.”.

“If you cannot hear your own voice, try increasing the relative amplification of the own-voice portion in the own-voice amplification menu of your hearing aid app.”

As is clear from the examples, the response can be brief or extensive.

A fourth step of the method is outputting the response to the user by the user interface. In analogy to receiving the query via a touchscreen or microphone, the response may be output in a similar way, e.g., displayed on the very same touchscreen or output by a speaker of the interaction unit or the hearing aid.

A fifth step of the method is identifying an actionable item (short: action) in the response by the data processing section, wherein the actionable item indicates an adjustment for the hearing aid. In other words: the generated response is analyzed by the data processing section to find actionable items in the response. Actionable items are phrases indicating an adjustment of the hearing aid. In particular, the adjustment is an adjustment of the signal processing performed by the hearing aid. For example, the actionable item may be the phrase “decrease volume” (equivalent: “volume down”), “increase volume” (equivalent: “volume up”), as used in the example response above, “use beamformer”, “decrease own-voice loudness”, “activate noise-cancelling” or the like. In these examples, the indicated adjustment is “increase volume”, “activate beamformer program”, “decrease relative amplification of the own voice”, activate noise-cancelling program”, respectively.

A sixth step of the method is generating an actionable control corresponding to the actionable item by the data processing section. The actionable control constitutes a context-aware actionable response, in addition to the response already described. The control is actionable in that it may be activated by the user to trigger an action associated with the control, namely the adjustment indicated by the actionable item on which generation of the actionable control is based. In other words: the actionable item is directly translated into a control element which can be activated by the user.

A seventh step of the method is presenting the actionable control to the user by the user interface. The actionable control may simply be displayed by the user interface as part of the interaction unit. In the alternative, it is also conceivable that the actionable control is a question read aloud to the user, asking whether to initiate a particular adjustment explicitly described to the user, which the user may simply activate by saying “yes”.

An eight step of the method is performing, if the actionable control is activated by the user, the corresponding adjustment for the hearing aid. Hence, adjustment of the hearing aid is not automatic, but requires explicit user intervention, namely activation of the actionable control. In a preferred embodiment, performing the corresponding adjustment for the hearing aid contains sending an adjustment command from the interaction unit to the hearing aid, thereby executing the adjustment, e.g., increasing the volume of the hearing aid such that sound is output louder as compared to the volume used before. Correspondingly, executing the adjustment takes the form of a macro which is triggered by activating the actionable control. In a preferred embodiment, the adjustment is selected from a group of adjustments containing: adjusting a volume of the hearing aid, changing a program of the hearing aid, and muting the hearing aid. However, other adjustments are possible, e.g., adjustments as already described above.

While it is preferred that the steps described above are performed in the given order, this is not strictly necessary.

The first to fourth steps as described implement a help and support system to assist the user by providing responses to user queries relating to use and operation of the hearing aid. The fifth to eight steps, then, are an addition to the assistance provided so far and enhance or augment this assistance by adding the actionable control, thereby generating a context-aware actionable response.

It is possible that a response does not contain any actionable item. In that case, the method as presented here does not apply and no actionable control is generated. However, the method presented here may be amended such that a message is output to the user that no actionable item could be identified. This message may be integrated into the response. In this application, it is assumed without loss of generality that the response does indeed contain at least one actionable item.

In a preferred embodiment, the response and the actionable control are output together by the user interface. For example, the response and actionable control are displayed on a screen of the interaction unit. In a possible embodiment, the query and response are displayed as speech bubbles and the actionable control is displayed along or in line with the speech bubbles, preferably with an additional indication of its actionability, e.g., in a different color.

In a preferred embodiment, the actionable control is dynamically appended to the response. For example, the actionable control is displayed immediately after the response, thereby directly augmenting the response and clearly indicating both as belonging together. In the alternative, the actionable control is output by highlighting the actionable item in the response, thereby indicating this part of the response as actionable, similar to a hyperlink in a text passage.

In a preferred embodiment, the data processing section accesses a database for generating an actionable control corresponding to the actionable item. The database may be part of the hearing system or separate therefrom. The database may be the same database as already described above in connection with generating the response or may be separate therefrom. In particular, the database maps hearing domain specific phrases to hearing aid parameter adjustments. The actionable item is compared to the hearing domain specific phrases. The adjustments mapped to the hearing domain specific phrase most similar to the actionable item is then selected and used to generate the actionable control. Upon activating this actionable control, then, the selected hearing aid parameter adjustment is executed. Thus, the database links certain phrases to particular adjustments which are most likely to address the issue connected to a particular phrase.

In a preferred embodiment, the actionable item is a phrase directly describing an adjustment for the hearing aid. Examples include “decrease volume”, “activate directional program”, or the like.

In a preferred embodiment, the actionable item comprises a first part indicating a hearing aid parameter to be adjusted and a second part indicating a particular adjustment for the hearing aid parameter. The hearing aid parameter may be “program”, “volume”, “own-voice amplification”, or the like. The adjustment, then, may be “louder”, “too loud”, “more”, “less”, a number or name of a hearing aid program, or the like. Put together, the actionable item may be “more volume”, “program 2”, or the like.

In a preferred embodiment, the user interface is a touchscreen, and the actionable control is displayed as a button on the touchscreen. The touchscreen is part of the interaction unit. In general, the touchscreen is preferably used to display a graphical user interface of a computer program running on the interaction unit. The computer program may also be configured to control the hearing aid, such that the interaction unit acts as a remote control to the hearing aid (hearing aid app).

In a preferred embodiment, the actionable control is labelled with a human-readable text describing the adjustment. The text may simply correspond to the actionable item itself.

For identifying the actionable item in the response, the data processing section preferably uses a large language model or natural language processing, preferably both, i.e., a large language model (LLM) with natural language processing (NLP). The details of the LLM and NLP are not important here, more important is that these concepts are used since they enable robust and reliable identification of actionable items. The LLM may be particularly trained for certain actionable items specifically related to adjustment of a hearing aid, e.g., the phrases as already described above.

The hearing aid generally has an input transducer, a signal processing unit for signal processing and an output transducer. The input transducer is usually a microphone. The output transducer is usually a speaker, also known as a loudspeaker, or receiver. The hearing aid is usually assigned to a single user and is only used by that user. The hearing aid is usually worn in or around the user's ear. The hearing aid may be binaural or monoaural. The hearing aid is used by a hearing-impaired user to improve hearing and to compensate for a corresponding hearing deficit or hearing loss of the user. In operation, the input transducer generates an input signal which is fed to the signal processing unit. The signal processing unit modifies the input signal and thereby generates an output signal, which is therefore a modified input signal. To compensate for hearing loss, the input signal is amplified with a preferably frequency-dependent amplification factor, for example according to the user's audiogram. The output signal is then output to the user via the output transducer. In the case of a hearing aid with a microphone and receiver, the microphone generates the input signal from sound signals in the environment and the receiver generates a sound signal from the output signal. The input signal and the output signal are electrical signals. In contrast, the sound signals from the environment and any sound signal emitted by the hearing aid are acoustic signals.

In a preferred embodiment, the interaction unit is a stand-alone mobile electronic device. Similar to the hearing aid, the device is usually-but not necessarily-assigned to a single user and is only used by that user, namely the user of the hearing aid. The device is mobile in that its general dimensions are such that it may easily be carried by the user and does not require permanent connections to other devices. The device is a stand-alone device in that it may be operated independent of other devices, in particular independent of the hearing aid. In a particularly preferred embodiment, the interaction unit is a smartphone. A smartphone is also an example of a stand-alone mobile electronic device; other examples include tablet PCs, notebooks, etc.

In a preferred embodiment, the method is implemented by way of a computer program running on the interaction unit. In particular, the computer program is a mobile application (app).

The inventive hearing system is configured for operation according to the method described above.

In conclusion, a method and hearing system have been described which enhance the user interaction within a help and support system, in particular a chatbot, which is implemented by the data processing section in connection with the interface of the interaction unit. Preferably, the help and support system is embedded in a mobile application for hearing aid users. The method and hearing system advantageously utilize a large language model to analyze chatbot-generated responses for specific actionable items. Upon detection of such an actionable item, e.g., the phrase “increase volume”, the hearing system dynamically generates a corresponding actionable control within the chatbot interface. This actionable control serves as a shortcut for an adjustment as indicated by the actionable item, enabling the user to trigger the respective action (adjustment) with a single click, thereby improving user experience and accessibility. In short, the invention implements context-aware actionable response generation in a help and support system (chatbot) for hearing aid users.

Other features which are considered as characteristic for the invention are set forth in the appended claims.

Although the invention is illustrated and described herein as embodied in a method of operating a hearing system and a hearing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration of a hearing system with a hearing aid and an interaction unit;

FIG. 2 is a flow chart showing a method of operating the hearing system of FIG. 1;

FIG. 3 is an illustration showing the method and the hearing system of FIGS. 1 and 2 in a different representation; and

FIG. 4 is an illustration showing an interface of the interaction unit during operation.

### DETAILED DESCRIPTION OF THE INVENTION

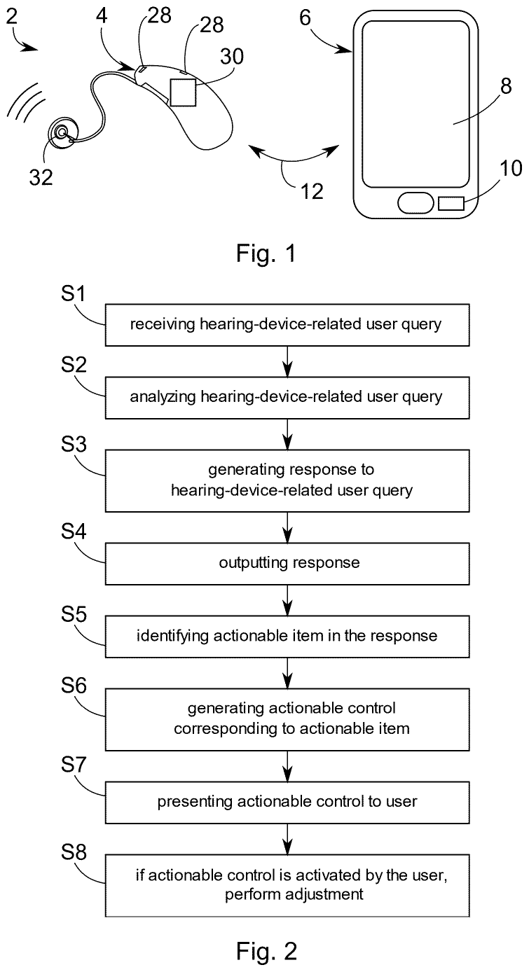

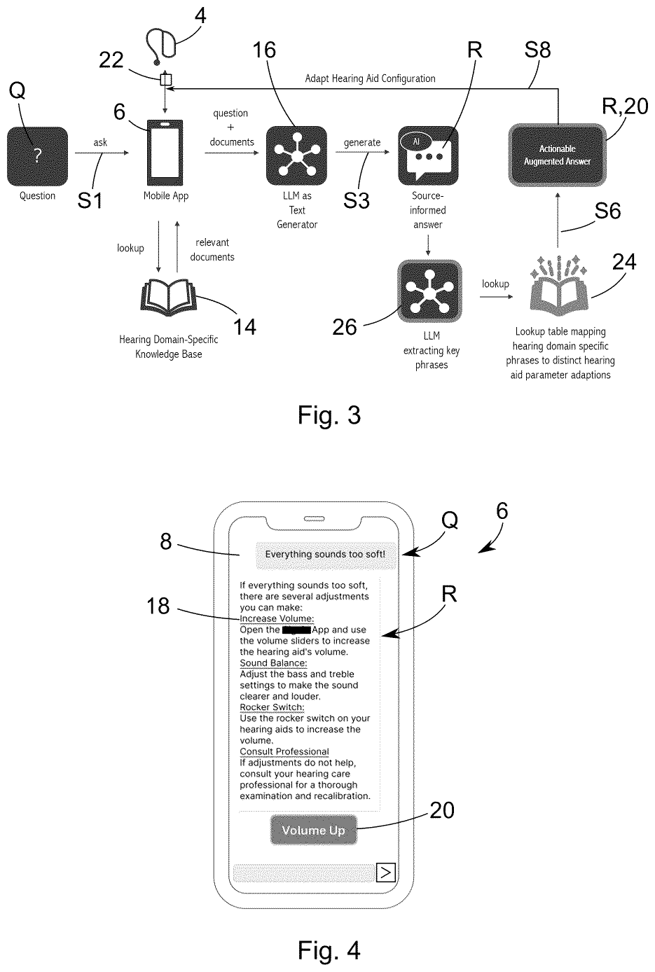

Referring now to the figures of the drawings in detail and first, particularly to FIG. 1 thereof, there is shown an inventive hearing system 2. A flowchart of an exemplary method of operating the hearing system 2 is shown in FIG. 2. FIG. 3, then, shows a different representation, emphasizing functional blocks relevant during the method.

The hearing system 2 has a hearing aid 4, an interaction unit 6, a user interface 8 for inputting a hearing-system-related user query Q, and a data processing section 10 coupled to the user interface 8. In the exemplary embodiment shown here, the interaction unit 6 is a device separate from the hearing aid 4 (remote interaction unit), but in principle both may be combined in a single device (integrated interaction unit, not shown). In FIG. 1, the interaction unit 6 and the hearing aid 4 are connected to each other for data exchange via connection 12, e.g., Bluetooth or WiFi connection. In the embodiment shown here, the user interface 8 is part of the interaction unit 6. In another possible embodiment (not shown), the interaction unit 6 and the hearing aid 4 are separate devices. In this application, it is assumed without loss of generality that the interaction unit is a remote interaction unit separate from the hearing aid.

A first step S1 of the method is receiving the hearing-device-related user query by the user interface 8. In the example shown here the user interface 8 is a touchscreen of the interaction unit 6 accepting the hearing-device-related user query Q as typed user input. The hearing-device-related user query Q is a phrase describing a problem or question the user experiences in connection with use or operation of the hearing aid 4. An example for the hearing-device-related user query Q is shown in FIG. 4 and reads: “Everything sounds too soft!”

A second step S2 of the method is analyzing the hearing-device-related user query Q by the data processing section 10. In the present example and as illustrated in FIG. 3, the data processing section 10 comprises a smart retriever for analyzing the query Q. In a retrieval phase, the smart retriever fetches the most relevant, e.g., semantically most similar, documents from a first database 14, here a hearing domain-specific knowledge base. In the example shown in FIG. 4, the database 14 is external to the hearing system 2 and accessed by the data processing section 10 via the internet.

A third step S3 of the method is generating a response R to the hearing-device-related user query Q by the data processing section 10. In the present example, data processing section 10 implements a chatbot for generating the response R in response to the hearing-device-related user query Q. As illustrated in FIG. 4, the user query Q and the response R thereby take the form of a dialogue between the user and the chatbot. As already hinted above, the data processing section 10 uses retrieval-augmented generation (RAG) when generating the response R. Hence, generating the response R constitutes a generation phase in which the coalesced and condensed context as defined by the documents retrieved in the retrieval phase are used to generate the response. In the embodiment shown here, the data processing section 10 uses a first large language model 16 for generating the response R to the hearing-device-related user query Q.

In the example shown in FIG. 4, the response R reads: “If everything sounds too soft, there are several adjustments you can make:
a) Increase Volume: Open the hearing aid app and use the volume sliders to increase the hearing aid's volume.
b) Sound Balance: Adjust the bass and treble settings to make the sound clearer and louder.
c) Rocker Switch: Use the rocker switch on your hearing aid to increase the volume.
d) Consult Professional: If adjustments do not help, consult your hearing care professional for a thorough examination and recalibration”.

A fourth step S4 of the method is outputting the response R to the user by the user interface 8. In FIG. 4, the response R is output by being displayed on the touchscreen of the interaction unit 6.

A fifth step S5 of the method is identifying an actionable item 18 (short: action) in the response R by the data processing section 10, wherein the actionable item 18 indicates an adjustment for the hearing aid 4. In other words: the generated response R is analyzed by the data processing section 10 to find actionable items 18 in the response R. Actionable items 18 are phrases indicating an adjustment of the hearing aid 4. In the example shown in FIG. 4, the actionable item 18 is the phrase “increase volume”. The indicated adjustment is “increase volume”, or the equivalent “volume up” as shown in FIG. 4. Thus, actionable item 18 is a phrase directly describing an adjustment for the hearing aid 4. The exemplary actionable item 18 shown in FIG. 4 comprises a first part, namely “volume”, indicating a hearing aid parameter to be adjusted and a second part, namely “increase”, indicating a particular adjustment for the hearing aid parameter.

A sixth step S6 of the method is generating an actionable control 20 corresponding to the actionable item 18 by the data processing section 10. The actionable control 20 constitutes a context-aware actionable response, in addition to the response R already described. The control 20 is actionable in that it may be activated by the user to trigger an action associated with the control 20, namely the adjustment indicated by the actionable item 18 on which generation of the actionable control 20 is based. In other words: the actionable item 18 is directly translated into a control element 20 which can be activated by the user.

A seventh step S7 of the method is presenting the actionable control 20 to the user by the user interface 8. In FIG. 4, the actionable control 20 is simply displayed by the user interface 8.

An eight step S8 of the method is performing, if the actionable control 20 is activated by the user, the corresponding adjustment for the hearing aid 4. Hence, adjustment of the hearing aid 4 is not automatic, but requires explicit user intervention, namely activation of the actionable control 20. In the exemplary embodiment shown here, performing the corresponding adjustment for the hearing aid 4 comprises sending an adjustment command 22 from the interaction unit 6 to the hearing aid 4, thereby executing the adjustment, e.g., increasing the volume of the hearing aid 4, i.e., adjusting a volume of the hearing aid 4.

In the embodiment shown here, the response R and the actionable control 20 are output together by the user interface 8. More specifically, the user interface 8 is a touchscreen, and the actionable control 20 is displayed as a button on the touchscreen. In FIG. 4, the query Q and response R are displayed as speech bubbles and the actionable control 20 is displayed in line with the speech bubbles and with an additional indication of its actionability, here in a different color. As illustrated in FIG. 4, the actionable control 20 is dynamically appended to the response R, namely immediately after the response R, thereby directly augmenting the response R and clearly indicating both as belonging together. Also, the actionable control 20 in FIG. 4 is labelled with a human-readable text (“volume up”) describing the adjustment. In the alternative, the text may simply correspond to the actionable item 18 itself, i.e., “increase volume” (not shown).

As illustrated in FIG. 3, the data processing section 10 accesses a second database 24 for generating the actionable control 20 corresponding to the actionable item 18. The database 24 shown here is separate from the hearing system 2. The database 24 is here separate from the first database 14 described above in connection with generating the response R, but they may also be combined. The second database 24 maps hearing domain specific phrases to hearing aid parameter adjustments. The actionable item 18 is compared to the hearing domain specific phrases. The adjustments mapped to the hearing domain specific phrase most similar to the actionable item 18 is then selected and used to generate the actionable control 20. Upon activating this actionable control 20, then, the selected hearing aid parameter adjustment is executed. Thus, second database 24 links certain phrases to particular adjustments which are most likely to address the issue connected to a particular phrase.

For identifying the actionable item 18 in response R, the data processing section 10 as shown here uses a second large language model 26 with natural language processing. The second large language model 26 is particularly trained for certain actionable items 18 specifically related to adjustment of a hearing aid 4.

The hearing aid 4 generally has a microphone 28 (input transducer), a signal processing unit 30 for signal processing, and a receiver 32 (output transducer). The hearing aid 4 is assigned to a single user (not shown) and is only used by that user, usually worn in or around the user's ear. The hearing aid 4 is used by a hearing-impaired user to improve hearing and to compensate for a corresponding hearing deficit or hearing loss of the user.

The interaction unit 6 shown here is a stand-alone mobile electronic device. Similar to the hearing aid 4, the interaction unit 6 is usually-but not necessarily-assigned to a single user and is only used by that user, namely the user of the hearing aid 4. In the exemplary embodiment shown here, the interaction unit 6 is a smartphone. The method described above may be implemented by way of a computer program (e.g., app) running on the interaction unit 6.

The following is a summary list of reference numerals and the corresponding structure used in the above description of the invention:
2 hearing system
4 hearing aid
6 interaction unit
8 user interface
10 data processing section
12 connection
14 first database
16 first large language model
18 actionable item
20 actionable control (control element)
22 adjustment command
24 second database
26 second large language model
28 microphone
30 signal processing unit
32 receiver
Q query (hearing-system-related user query)
R response
S1 first step
S2 second step
S3 third step
S4 fourth step
S5 fifth step
S6 sixth step
S7 seventh step
S8 eight step

1. A method for operating a hearing system having a hearing aid, an interaction unit, a user interface for inputting a hearing-system-related user query, and a data processor coupled to the user interface, which comprises the steps of:
receiving a hearing-device-related user query by the user interface;
analyzing the hearing-device-related user query by the data processor;
generating a response to the hearing-device-related user query by the data processor;
outputting the response to the user by the user interface;
identifying an actionable item in the response by the data processor, wherein the actionable item indicates a corresponding adjustment for the hearing aid;
generating an actionable control corresponding to the actionable item by the data processor;
presenting the actionable control to a user by the user interface; and
performing, if the actionable control is activated by the user, the corresponding adjustment for the hearing aid.

2. The method according to claim 1, wherein a performance of the corresponding adjustment for the hearing aid includes sending an adjustment command from the interaction unit to the hearing aid, thereby executing the corresponding adjustment.

3. The method according to claim 1, which further comprises selecting the corresponding adjustment from the group consisting of: adjusting a volume of the hearing aid, changing a program of the hearing aid, and muting the hearing aid.

4. The method according to claim 1, wherein the data processor implements a chatbot for generating the response in response to the hearing-device-related user query.

5. The method according to claim 1, which further comprises outputting together the response and the actionable control via the user interface.

6. The method according to claim 1, wherein the actionable control is dynamically appended to the response.

7. The method according to claim 1, wherein:
the data processor accesses a database for generating the actionable control corresponding to the actionable item; and
the database maps hearing domain specific phrases to hearing aid parameter adjustments.

8. The method according to claim 1, wherein the actionable item is a phrase directly describing an adjustment for the hearing aid.

9. The method according to claim 1, wherein the actionable item includes a first part indicating a hearing aid parameter to be adjusted and a second part indicating a particular adjustment for the hearing aid parameter.

10. The method according to claim 1, wherein the user interface is a touchscreen, and the actionable control is displayed as a button on the touchscreen.

11. The method according to claim 1, wherein the actionable control is labelled with a human-readable text describing the corresponding adjustment.

12. The method according to claim 1, wherein the data processing section uses a large language model for identifying the actionable item in the response.

13. The method according to claim 1, wherein the data processor uses natural language processing for identifying the actionable item in the response.

14. The method according to claim 1, wherein the data processor uses a large language model for generating the response to the hearing-device-related user query.

15. The method according to claim 1, wherein the data processor uses retrieval-augmented generation when generating the response.

16. The method according to claim 1, wherein the interaction unit is a stand-alone mobile electronic device.

17. The method according to claim 1, wherein the interaction unit is a smartphone.

18. The method according to claim 1, wherein the method is implemented by way of a computer program running on the interaction unit.

19. A hearing system configured for implementing the method according to claim 1.
